(19) United States
(12) Patent Application Publication
(10) Pub. No.: US 2012/0076939 A1
(43) Pub. Date: Mar. 29, 2012

(54) METHOD OF PRODUCING ENDLESS BAND-SHAPED BODY

(75) Inventors: Yuichi YASHIKI, Kanagawa (JP); Shuhei YAMAZAKI, Kanagawa (JP); Tomoki FUSE, Kanagawa (JP)

(73) Assignee: FUJI XEROX CO., LTD., Tokyo (JP)

(21) Appl. No.: 13/016,523

(22) Filed: Jan. 28, 2011

(30) Foreign Application Priority Data
Sep. 28, 2010 (JP) 2010-216682

(51) Int. Cl. B05D 3/02; B05D 3/00

(52) U.S. Cl. 427/318; 427/372.2; 427/388.1

(57) ABSTRACT

A method of producing an endless band-shaped body includes: forming a coating film by applying film-forming resin solution to an outer circumferential surface of a cylindrical core body that is being rotated around an axis of the cylindrical core body by a rotation device in a state where the axis of the cylindrical core body is horizontally directed, the cylindrical core body undergoing deformation into an oval cylindrical shape due to its own weight when left unsupported with the axis of the cylindrical core body directed horizontally; and drying the coating film formed on the outer circumferential surface of the rotating cylindrical core body. The rotation device includes plural rolls each disposed at a position that would touch an axial end region of the outer circumferential surface of the cylindrical core body in an undeformed state, and the cylindrical core body being supported by the first and second rolls.

### BACKGROUND

1. Technical Field

The present invention relates to a method of producing an endless band-shaped body.

2. Related Art

In image forming devices, endless band-shaped bodies (endless belts) formed of resins have been widely used as an intermediate transfer body to which a visible image formed on a surface of an image holder is temporarily transferred before being transferred to a medium, or as a medium transport member that transfers a medium retained on a surface of the medium transport member.

The flexible endless belt substrate is produced by rolling a metal thin plate or a resin thin film, and combining the ends of the thin plate or thin film by a method such as welding or adhesion. The seam of the belt substrate produced by welding the metallic thin plate can be smoothened by a method whereby the seam portion is polished well such that the smoothness becomes comparable to that of a plate material.

### SUMMARY

According to an aspect of the invention, there is provided a method of producing an endless band-shaped body, comprising:

an application process of forming a coating film by applying a film-forming resin solution to an outer circumferential surface of a cylindrical core body that is being rotated around an axis of the cylindrical core body by a rotation device in a state in which the axis of the cylindrical core body is horizontally directed, the cylindrical core body undergoing deformation into an oval cylindrical shape due to its own weight when left unsupported in a state in which the axis of the cylindrical core body is directed horizontally; and

a drying process of drying the coating film formed on the outer circumferential surface of the rotating cylindrical core body,

the rotation device including at least one first roll and at least one second roll,

the at least one first roll being disposed at at least one position such that the at least one first roll would touch a first end region of the outer circumferential surface of the cylindrical core body in an undeformed state, the first end region being located at one end in the axial direction of the cylindrical core body,

the at least one second roll being disposed at at least one position such that the at least one second roll would touch a second end region of the outer circumferential surface of the cylindrical core body in an undeformed state, the second end region being located at the other end in the axial direction of the cylindrical core body, and

the cylindrical core body being supported by the first and second rolls.

### BRIEF DESCRIPTION OF THE DRAWINGS

Exemplary embodiments of the present invention will be described in detail based on the following figures, wherein:

FIG. 1 is an enlarged cross-sectional view of a welding fusion portion of a cylindrical body;

FIG. 2 is a side view that shows a cylindrical core body in a state in which the cylindrical core body is deformed into an oval cylindrical shape with its axis directed horizontally, due to its own weight;

FIG. 3 is a perspective view that shows an example of a rotation device for a cylindrical core body that is used in an exemplary embodiment of the invention;

FIG. 4 is a side view of a rotation device, which shows a cylindrical core body viewed in the axial direction;

FIG. 5 is an enlarged view of a portion at which a roll and a cylindrical core body contact each other in a case in which a roll having a diameter difference is used;

FIG. 6 is a diagram for explaining the positional relationship between a regulation member and a cylindrical core body;

FIG. 7 is a side view that shows another example of a rotation device of a cylindrical core body that is used in an exemplary embodiment of the invention;

FIG. 8 is a diagram explaining a spiral coating method;

FIG. 9 is a diagram that shows a state in which a shielding member is disposed at the top of the cylindrical core body;

FIG. 10 is a side view that shows a rotation device used in Example 3; and

FIG. 11 is a diagram that shows a state in which an endless belt substrate is stretched by being wound around two rolls.

### DETAILED DESCRIPTION

A method of producing an endless band-shaped body according to an exemplary embodiment of the invention is described in detail below. In the drawings, members other than members that are necessary for explanation are omitted, as appropriate, in order to facilitate the understanding. Further, members having similar functions are designated by the same reference character throughout the drawings, and explanations thereof are omitted in some cases.

The method of producing an endless band-shaped body according to the present exemplary embodiment is described with reference to an exemplary method in which the endless band-shaped body is an endless belt, more specifically, an intermediate transfer belt. However, the production method according to the present exemplary embodiment may be applied to production of other endless band-shaped bodies such as sheet transfer belts.

Application Process

The method of producing an endless band-shaped body of the present exemplary embodiment includes an application process of forming a coating layer by applying a film-forming resin solution to the outer circumferential surface of the cylindrical core body that is being rotated around the axis of the cylindrical core body by a rotation device in a state in which the axis of the cylindrical core body is horizontally directed, the cylindrical core body undergoing deformation into an oval cylindrical shape due to its own weight when left unsupported with the axis of the cylindrical core body directed horizontally. The term “oval cylindrical shape” as used herein refers to a quasi-cylindrical shape of which the cross-section orthogonal to the axis of the quasi-cylinder is deviated from a true circle such that the height in the vertical direction of the cross-section is shorter than the diameter of a circle having the same circumferential length as that of the cross-section. Although the cross-sectional shape of the quasi-cylindrical shape generally looks like an ellipse, the cross-sectional shape is not limited to a true ellipse, and deviation from the true ellipse is permitted as long as the shape results from deformation of a cylindrical material due to its own weight. Further, the term “touch” as used to represent the positional relationship between a roll and (an end region of) the outer circumferential surface of the cylindrical core body in an undeformed state indicates that the roll is positioned such that an imaginary surface representing the outer circumferential surface of the roll in an undeformed state and an imaginary surface representing (an end region of) the outer circumferential surface of the cylindrical core body in an undeformed state would touch each other only at one line of contact (i.e., the distance between the center of the roll and the center of the cylindrical core body is equal to half the sum of the outer diameter of the roll in the undeformed state and the outer diameter of the cylindrical core body in the undeformed state), or would cross each other at two points but the difference between the distance between the center of the roll and the center of the cylindrical core body and half the sum of the outer diameter of the roll in the undeformed state and the outer diameter of the cylindrical core body in the undeformed state is a practical bite amount of the roll for supporting the cylindrical core body. Similarly, when the term “touch” is used to represent the positional relationship between a roll and a specific position, the term indicates that the roll is positioned such that an imaginary surface representing the outer circumferential surface of the roll in an undeformed state would contact the specific position (i.e., the distance between the center of the roll and the specific position is equal to half the outer diameter of the roll in the undeformed state), or the specific position would be positioned at the inner side of the imaginary surface rather than on the surface but the difference between the distance between the center of the roll and the specific position and half the outer diameter of the roll in the undeformed state is a practical bite amount of the roll for supporting the cylindrical core body. The term “bite” or “biting” represents deformation of a roll or caused by a contact pressure between the roll and another surface, and “bite amount” refers to the deviation, from half the outer diameter of the roll, of the distance between a point on the outer circumferential surface of the roll and the center of the roll caused by a contact pressure between the roll and the another surface.

A polyimide resin (PI) or a polyamideimide resin (PAI) may be used as the film-forming resin for forming an endless belt, from the viewpoint of for example, strength, dimensional stability, and heat resistance. However, the film-forming resin is not limited thereto. The PI or PAI may be selected from various known PIs or PAIs. In the case of forming a PI film, a precursor of the PI may be applied in some cases.

The PI precursor solution serving as a film-forming resin solution can be obtained by allowing a tetracarboxylic acid dianhydride and diamine compound to react with each other in a solvent. The type of each ingredient is not specifically limited. A PI precursor obtained by allowing an aromatic tetracarboxylic acid dianhydride and an aromatic diamine compound to react with each other is preferable from the viewpoint of film strength.

Representative examples of the aromatic tetracarboxylic acid dianhydride include: pyromellitic acid dianhydride, 3,3′,4,4′-biphenyl tetracarboxylic acid dianhydride, 3,3′,4,4′-benzophenone tetracarboxylic acid dianhydride, 2,3,4,4′-biphenyl tetracarboxylic acid dianhydride, 2,3,6,7-naphthalene tetracarboxylic acid dianhydride, 1,2,5,6-naphthalene tetracarboxylic acid dianhydride, 2,2-bis(3,4-dicarboxyphenyl)ether dianhydride; esters of these tetracarboxylic acid dianhydrides; and mixtures of two or more of these tetracarboxylic acid dianhydrides and/or tetracarboxylic acid dianhydride esters.

Examples of the aromatic diamine compound include para-phenylenediamine, meta-phenylenediamine, 4,4′-diaminodiphenyl ether, 4,4′-diaminophenyl methane, benzidine, 3,3′-dimethoxybenzidine, 4,4′-diaminodiphenyl propane, and 2,2′-bis[4-(4-aminophenoxy)phenyl]propane.

A PAI can be obtained by polycondensation reaction of equimolar amounts of an acid anhydride (such as trimellitic acid anhydride, ethylene glycol bis(anhydrotrimellitate), propylene glycol bis(anhydrotrimellitate), pyromellitic acid anhydride, benzophenone tetracarboxylic acid anhydride, or 3,3′,4,4′-biphenyl tetracarboxylic acid anhydride) and a diamine (such as those described above). Since a PAI has an amido group, the PAI easily dissolves in a solvent even when an imidization reaction has progressed substantially. Therefore, a 100%-imidized PAI is preferable.

The solvent contained in the film-forming resin solution may be an aprotic polar solvent such as N-methylpyrrolidone, N,N-dimethylacetamide, or acetamide. There is no limitation on the concentration, viscosity, or the like of the film-forming resin solution. In the present exemplary embodiment, the solids concentration of the film-forming resin solution is preferably from 10 mass % to 40 mass %, and the viscosity of the film-forming resin solution is preferably from 1 Pa·s to 100 Pa·s.

Conductive particles may be incorporated into the film-forming resin solution, as necessary. Examples of the conductive particles to be dispersed in the resin solution include particles of: carbon-containing substances such as carbon black, carbon fibers, carbon nanotubes, and graphite; metals such as copper, silver, or aluminum, and alloys thereof; conductive metal oxides such as tin oxide, indium oxide, and antimony oxide; and whiskers such as potassium titanate. Among them, carbon black is preferable from the viewpoint of, for example, dispersion stability in liquid, impartment of semi-conductive properties, and costs.

The method for dispersing the conductive particles may be a known method, such as by using a ball mill, a sand mill (bead mill), or a jet mill (a counter-collision disperser). A surfactant, a leveling agent, or the like may be added as a dispersion aid. The dispersion concentration of the conductive particles is preferably from 10 parts to 40 parts, more preferably from 15 parts to 35 parts, with respect to 100 parts of resin. Here, part(s) represents part(s) by weight, and the same shall apply hereinafter.

The material for the cylindrical core body used in the present exemplary embodiment is preferably stainless steel from the viewpoint of processability and durability. The width (length in the axial direction) of the cylindrical core body should be equal to or greater than that of the desired endless band-shaped body. In order to provide sufficient margin area at ends, the width is preferably longer than that of the desired endless band-shaped body by from about 10% to about 40%. The circumferential length of the cylindrical core body may be equal to or slightly greater than the circumferential length of the desired endless band-shaped body.

The thickness of the cylindrical core body is preferably from about 0.1 mm to about 2 mm. A thickness smaller than this range makes it difficult to perform welding during preparation of the cylindrical core body. A thickness greater than this range makes it difficult to roll a metal plate into a cylindrical shape during preparation of the cylindrical core body. The cylindrical core body may be prepared by cutting a quadrilateral metallic plate so as to have a predetermined width and length, rolling the metallic plate, and bonding both ends of the metallic plate by welding. A metallic cylindrical body can be obtained thereby.

There are a variety of welding methods, such as gas welding, arc welding, plasma welding, electric resistance welding, tungsten inert gas welding (TIG welding), metal inert gas welding (MIG welding), and metal active gas welding (MAG welding). An optimal method may be selected according to the kind of metal.

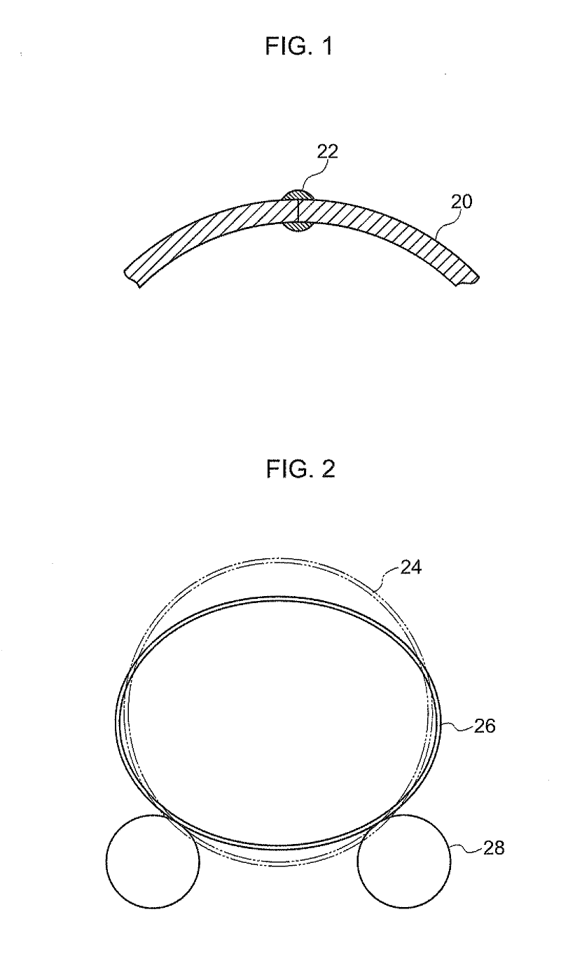

The weld-bonding portion protrudes from the original metallic plate. FIG. 1 shows an enlarged cross-sectional view of the weld-bonding portion of the cylindrical body. As shown in FIG. 1, protruding portions 22 occur respectively on the inner and outer surfaces of the cylindrical body 20. The protruding portions 22 may be polished to provide a smooth surface. However, since the welded portion has a heat history different from that of the original metallic plate, welded portion has a different hardness, and a difference in height tends to remain even in a case in which polishing has been performed.

In a case in which an austenite-based stainless steel such as SUS 304 of HS standard or a ferrite-based stainless-steel such as SUS 430 is used, the weld-bonding portion is softened by heat. Therefore, the entire cylindrical body after welding may be heated to a temperature of from 1050° C. to 1100° C., which is a solution heat treatment temperature, so as to soften the entire cylindrical body and to homogenize the hardness; then, the outer circumferential surface of the cylindrical body may be polished such that the entire outer circumferential surface of the finished cylindrical body is smooth, and the cylindrical body thus obtained may be used as the cylindrical core body. In this case, the entire cylindrical core body is softened, and the strength thereof is decreased. Therefore, a smaller thickness of the plate results in a higher tendency towards deformation at the time of polishing, and thus is less suitable. The thickness of the plate is preferably from about 1 mm to about 2 mm.

In a case in which a martensite-based stainless steel such as SUS 410 is used, although the weld-bonding portion is similarly softened, it is possible to perform quenching after the heat treatment. Thus, the entire cylindrical body after welding may be heated to a temperature of from 1000° C. to 1100° C., which is a solution heat treatment temperature, and then quenched to harden the entire cylindrical body, and then polished.

In a case in which precipitation hardening stainless steel such as SUS631, the weld-bonding portion is hardened. Thus, the entire cylindrical body after welding may be heated to a temperature of from 480° C. to 550° C., which is a hardening temperature, so as to harden the entire cylindrical body, and then the cylindrical body may be polished such that the entire outer circumferential surface of the finished cylindrical body is smooth.

In regard to the polishing method, the removal of the protruding portion is preferably performed by grinding with a grindstone. When this method is used, the surface of the polished portion is rough; therefore, after grinding, it is preferable to finish the surface by, for example, buff polishing or vertical polishing.

A release layer may be formed on the outer circumferential surface of the cylindrical core body. The release layer can be formed by uniformly applying a release agent to the entire outer circumferential surface of the cylindrical core body. As a result, the entire area of the outer circumferential surface of the cylindrical core body is provided with release properties. A silicone-based or fluorine-based oil that has been modified to acquire heat-resistance is an effective release agent. Another example of release agents is an aqueous release agent in which silicon resin particles are dispersed in water. The release layer can be formed by applying a release agent to the outer circumferential surface of the cylindrical core body, and removing the solvent by drying, and, optionally, subjecting the cylindrical core body to baking treatment.

The cylindrical core body may have poor flexibility due to its large thickness in the case of austenite-based stainless steel and ferrite-based stainless steel, and due to its high hardness even with a small thickness in the case of martensite-based stainless steel and precipitation hardening stainless steel. Therefore, when the cylindrical core body (endless belt substrate 10 in FIG. 11) is stretched by being wound around rolls 12 and receives tension as shown in FIG. 11, deformation following the outer circumference of the rolls may remain in the cylindrical core body, as a result of which the cylindrical core body cannot be rotated smoothly in some cases.

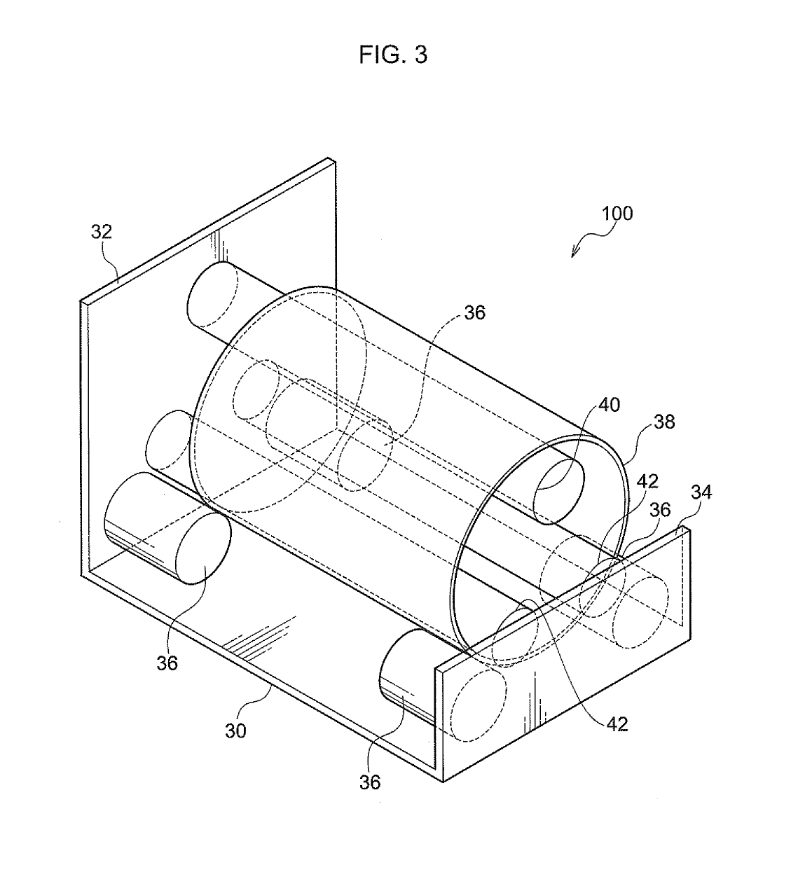

Further, in a case in which the cylindrical core body is disposed with its axis directed horizontally, and a pair of cylindrical rolls (two in number) are arranged at each axial-direction end portion of the cylindrical core body, and the cylindrical core body is supported by the cylindrical rolls, the cylindrical core body deforms due to inability to support its own weight in some cases depending on the material or thickness of the cylindrical core body. FIG. 2 is a side view that shows a cylindrical core body in a state in which the cylindrical core body with its axis directed horizontally has deformed into an oval cylindrical shape due to its own weight. In FIG. 2, reference numeral 24 designates a cylindrical core body in an undeformed state, and reference numeral 26 represents the cylindrical core body in a state in which the cylindrical core body has deformed into an oval cylindrical shape due to its own weight.

As shown in FIG. 2, when the cylindrical core body is placed on rolls 28, two of which are disposed per one side, the cylindrical core body deform into an oval cylindrical shape in some cases due to its own weight. When a driving force is applied to the rolls 28 so as to rotate the cylindrical core body in the deformed state around its axis, the film-forming resin solution cannot be applied stably, and there is also a possibility that the cylindrical core body may vibrate and fall down from the rolls 28.

In order to prevent the deformation of the cylindrical core body, the material constituting the cylindrical core body should be selected in accordance with the purpose, and/or the thickness of the cylindrical core body should be thickened. However, prevention of the deformation of the cylindrical core body by selecting suitable materials decreases the freedom in the selection of the material constituting the cylindrical core body. Further, prevention of the deformation of the cylindrical core body by increasing the thickness thereof leads to an increase in the weight of the cylindrical core body, and causes difficulty in handling in some cases.

FIG. 3 is a perspective view that shows an example of a rotation device of a cylindrical core body used in the present exemplary embodiment.

The rotation device 100 includes a rectangular bottom plate 30, a pair of side plates 32 and 34 that are disposed to stand at opposite ends of the bottom plate 30, and rolls 36 that are rotatably attached to the opposing surfaces of the side plate 32 and the side plate 34. The cylindrical core body 38 is supported by the rolls 36 from the bottom side at the respective axial-direction end portions of the cylindrical core body 38 such that the axis of the cylindrical core body 38 is horizontally directed.

FIG. 4 is a side view of the rotation device 100, which shows the cylindrical core body 38 viewed in the axial direction. As is shown in FIG. 4, the rolls 36 are disposed at positions such that the rolls 36 would touch the outer circumferential surface of the cylindrical core body 38 in an undeformed state.

The rolls 36 are driven to rotate by an external power source (not shown), and each may be a roller-shaped rotatable member formed of resin or rubber. In FIG. 3, two rolls 36 are disposed at each end portion of the cylindrical core body 38. The number of rolls 36 disposed at each end portion of the cylindrical core body 38 (i.e., the number of rolls 36 per one end of the cylindrical core body 38) is preferably equal to or greater than a value N obtained by the equation N=L/100 (rounding down to the nearest integer) wherein L (mm) represents the diameter of the cylindrical core body 38. When the number is fewer than N, the cylindrical core body 38 may not be maintained in a cylindrical shape. The number of rolls 36 per one end of the cylindrical core body 38 is preferably larger. However, a larger number of rolls 38 are more difficult to arrange. Therefore, the upper limit of the number of rolls 36 per one end of the cylindrical core body 38 is about twice the value of L/100 (rounding down to the nearest integer). Each of the rolls 36 contacts only either of the end portions of the cylindrical core body 38, and should not contact a portion of the cylindrical core body 38 at which a coating film is to be formed. The width of the portion at which each roll 36 contacts the cylindrical core body 38 may be from 5 mm to 30 mm, in terms of the width in the axial direction from the corresponding end of the cylindrical core body 38.

The rotation device 100 further includes a support roll 40 that contacts a region (directly above the axis of the cylindrical core body 38 in the case of FIG. 3) of the inner circumferential surface of the cylindrical core body 38, and the region is located at the upper side, in terms of vertical direction, of the axis position of the cylindrical core body 38. The support roll 40 may be disposed such that the support roll 40 would touch the inner circumferential surface of the cylindrical core body 38 in an undeformed state. When the support roll 40 is provided in the rotation device 100, the cylindrical core body 38 is supported from the inside; therefore, deformation of the cylindrical core body 38 due to its own weight is suppressed further effectively.

When the rotation device 100 includes the support roll 40, deformation of the cylindrical core body 38 due to its own weight is effectively suppressed even in a case in which the number of rolls 36 disposed at each end portion of the cylindrical core body 38 is fewer than L/100 (rounding down to the nearest integer).

The rotation device 100 further includes counter rolls 42 that contact the inner circumferential surface of the cylindrical core body 38 and that face the rolls 36 with the cylindrical core body 38 interposed therebetween. In the present exemplary embodiment, the counter rolls 42 are attached to the side plate 32, and is not fixed to the side plate 34. As a result of the provision of the counter rolls 42, the cylindrical core body 38 is urged towards the rolls 36. Since the cylindrical core body 38 is urged towards the rolls 36, the frictional force between the rolls 36 and the cylindrical core body 38 is increased. Therefore, when the rolls 36 are driven to rotation by an external power source (not shown) so as to apply a driving force that cause the cylindrical core body 38 to rotate around its axis, slippage due to insufficiency of the frictional force between the rolls 36 and the cylindrical core body 38 is prevented.

Since the counter rolls 42 do not contact the outer circumferential surface of the cylindrical core body 38, to which the film-forming resin solution is to be applied, each of the counter rolls 42 may be a roll that extends over the length of the cylindrical core body 38 in the axial direction as shown in FIG. 3, or a roll of which the axial length is comparable with that of the rolls 36.

In the rotation device 100, the counter rolls 42 are provided such that all of the rolls 36 face corresponding counter rolls 42. However, the cylindrical core body 38 can be urged towards the rolls 36 by providing at least one counter roll 42 in another manner, and, therefore, it is not necessary that the counter rolls 42 be provided to face all of the rolls 36. For example, a counter roll may be provided so as to contact the inner circumferential surface at a position directly below the axis of the cylindrical core body 38.

When installing the cylindrical core body 38 in the rotation device 100, the counter rolls 42 hamper the installation. Therefore, the cylindrical core body 38 is installed in a state in which the side plate 34 is not attached, and then the side plate 34 is attached to the bottom plate 30.

When the roll 36 is driven to rotate in a state in which the cylindrical core body 38 has been installed in the rotation device 100, the cylindrical core body 38 is rotated around the axis by the frictional force between the cylindrical core body 38 and the rolls 36 that is generated due to the weight of the cylindrical core body 38 itself. When driving the cylindrical core body 38 to rotate, it is preferable that all of the rolls 36 are driven to rotate in order to prevent slippage.

In order to prevent the cylindrical core body 38 from vibrating in the axial direction when rotated around its axis, a roll that has a smaller-diameter portion may be used as a roll 36, wherein the smaller-diameter portion is provided as a portion of the roll at one side in the axial direction at which the roll contacts the cylindrical core body, and the smaller-diameter portion has a smaller diameter than that of a portion of the roll at the other side at which the roll does not contact the cylindrical core body.

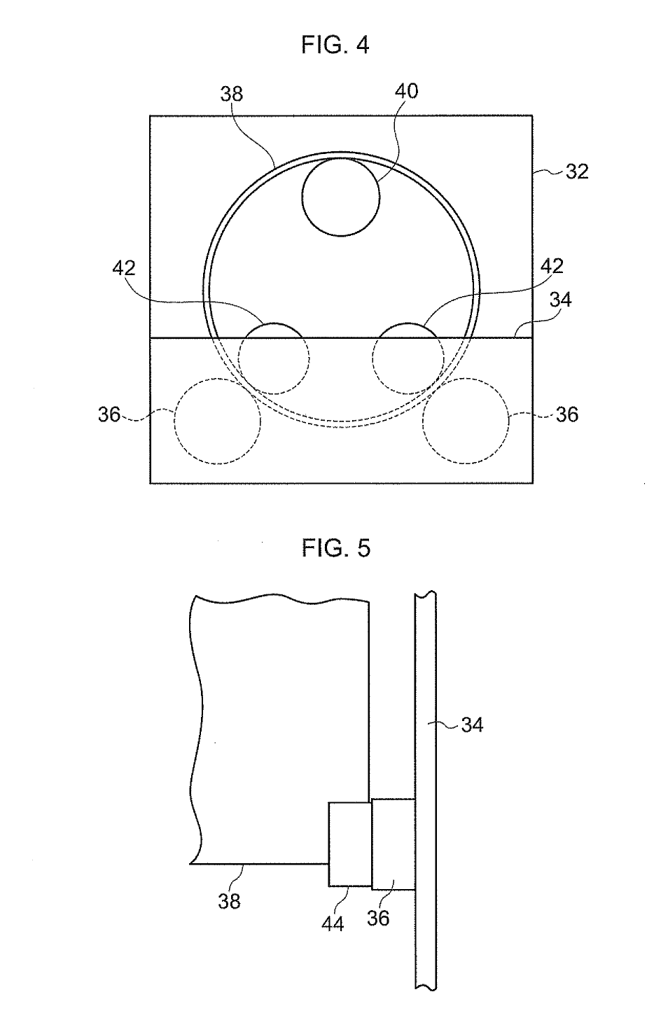

FIG. 5 shows an enlarged view of a contact portion of a roll and the cylindrical core body in a case in which the roll is provided with the smaller-diameter portion. In FIG. 5, the cylindrical core body 38 is supported by a smaller-diameter portion 44 provided in the roll 36. The cylindrical core body 38 is supported by the smaller-diameter portion 44, as a result of which the movement of the cylindrical core body 38 in the axial direction is suppressed when the cylindrical core body 38 is rotated around the axis; consequently, the vibration of the cylindrical core body 38 in the axial direction is suppressed.

In order to prevent the vibration of the cylindrical core body 38 in the axial direction, a regulation member that contacts an end of the cylindrical core body 38 in the axial direction and regulates the movement of the cylindrical core body 38 in the axial direction may be provided in the rotation device.

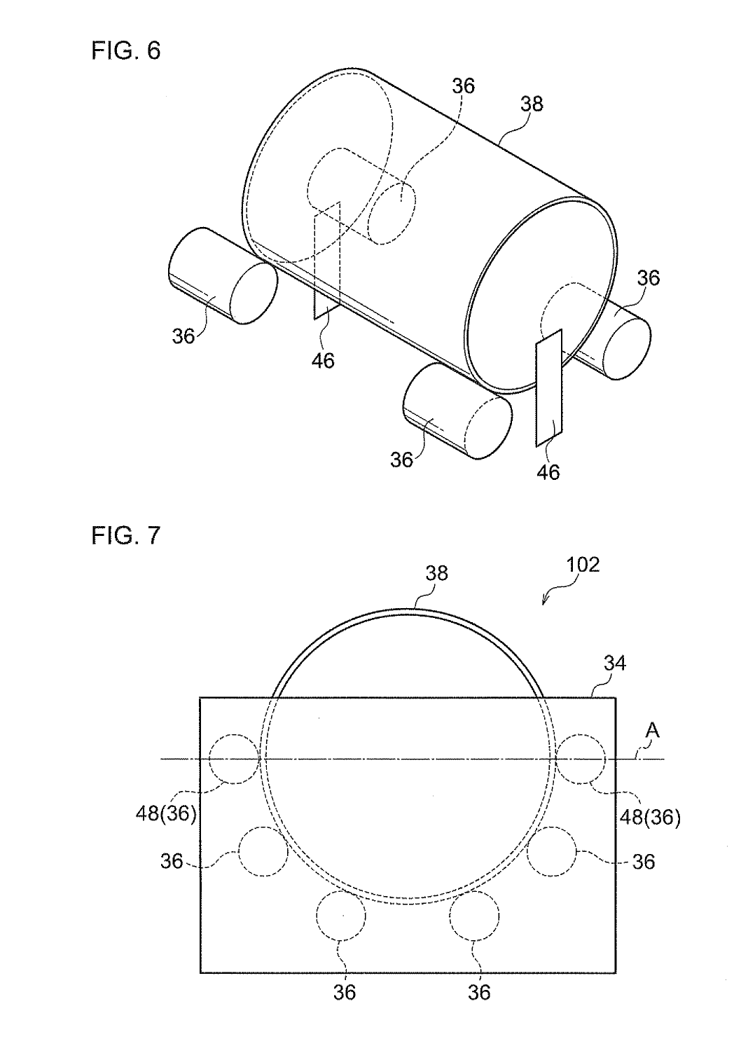

FIG. 6 is a diagram for explaining the positional relationship between the regulation member and the cylindrical core body. In order to facilitate the understanding of the positional relationship between the regulation member and the cylindrical core body, FIG. 6 shows only the cylindrical core body 38, the rolls 36, and restriction plates 46 serving as regulation members.

FIG. 7 is a side view that shows another example of the rotation device for the cylindrical core body used in the present exemplary embodiment.

A rotation device 102 includes a pair of pinching rolls 48 that are disposed at positions at which a horizontal imaginary line A passing through the axis of the cylindrical core body 38 in an undeformed state and the outer circumference of the cylindrical core body 38 intersect with each other when the cylindrical core body 38 is viewed in the axial direction (the direction perpendicular to the paper surface of FIG. 7). At the lower part of the cylindrical core body 38, rolls 36 are provided at equal spaces along the circumferential direction of the cylindrical core body 38.

The deformation of the horizontal direction of the cylindrical core body 38 is restricted by being pinched by the pair of pinching rolls 48. Therefore, the cylindrical core body 38 rotates around its axis without being deformed by its own weight.

In addition, the rotation device 102 may further include a support roll that contacts a region of the inner circumferential surface of the cylindrical core body 38 that is at the upper (in terms of vertical direction) side of the axial position of the cylindrical core body 38.

In the rotation device 100, all of the rolls 36 may be driven to rotate by an external power source, or, alternatively, only some of the rolls 36 may be driven to rotate by an external power source. In a case in which only some of the rolls 36 are driven for rotation, the rolls which are not driven to rotate are rotated according to the rotation of the cylindrical core body 38. Further, it is preferable that the circumferential velocities of all of rolls 36 that are driven to rotate are the same as each other. In the rotation device 102, all of the rolls 36 and the pinching rolls 48 may be driven to rotate by an external power source, or, alternatively, only some of the rolls 36 and the pinching rolls 48 may be driven to rotate by an external power source. In a case in which only some of the rolls 36 and the pinching rolls 48 are driven for rotation, the rolls which are not driven to rotate are rotated according to the rotation of the cylindrical core body 38. Further, it is preferable that the circumferential velocities of all of rolls 36 and pinching rolls 48 that are driven to rotate are the same as each other.

When the film-forming resin is a PI resin, a lot of gases are generated during heating reaction of a PI precursor, and the resultant PI resin film tends to have paper-lantern-shaped expansions at portions due to the generated gases; this phenomenon is remarkable particularly when the thickness of the film is so large as to exceed 50 μm. The gases generated during the heating reaction include an evaporated gas of residual solvent and water vapor generated during the reaction.

In order to prevent the expansion, for example, it is preferable to roughen the surface of the cylindrical core body to an arithmetic average roughness Ra of from 0.2 μm to 2 μm (or from about 0.2 μm to about 2 μm), as in a technique described in JP-A No. 2002-160239. When the arithmetic average roughness Ra is smaller than 0.2 μm, gases such as volatile gas or water vapor do not easily go out in some cases. When the arithmetic average roughness Ra is greater than 2 μm, the surface of the produced endless belt is uneven in some cases. The roughening method may be selected from, for example, blasting, cutting, sandpapering, or the like. Even in a case in which roughening is performed, since the cylindrical core body may have the same hardness in the plate portion and the welding portion, the roughnesses in those portions may be made equal to each other, which is preferable. As a result of the roughening, gas generated from the PI resin may be discharged to the outside through a slight gap present between the surface of the cylindrical core body and the PI resin film, and, therefore, expansion does not occur.

Before applying the film-forming resin solution to the surface of the cylindrical core body, a masking member, which is an example of a detachment assistant member, may be wound around and attached to both end regions of the cylindrical core body. Examples of masking members that can be used include a resin film such as of polyester or polypropylene, and a pressure-sensitive adhesive tape of which the substrate is a paper material such as crepe paper or flat paper. The width of the pressure-sensitive adhesive tape is preferably from about 10 mm to about 25 mm. The adhesive material of the pressure-sensitive adhesive tape is preferably an acrylic adhesive material, and more preferably a material that does not remain on the surface of the cylindrical core body when the pressure-sensitive adhesive tape is detached from the surface of the cylindrical core body.

In the present exemplary embodiment, the method of coating the film-forming resin solution is not particularly limited. For example, a spiral coating method may be used.

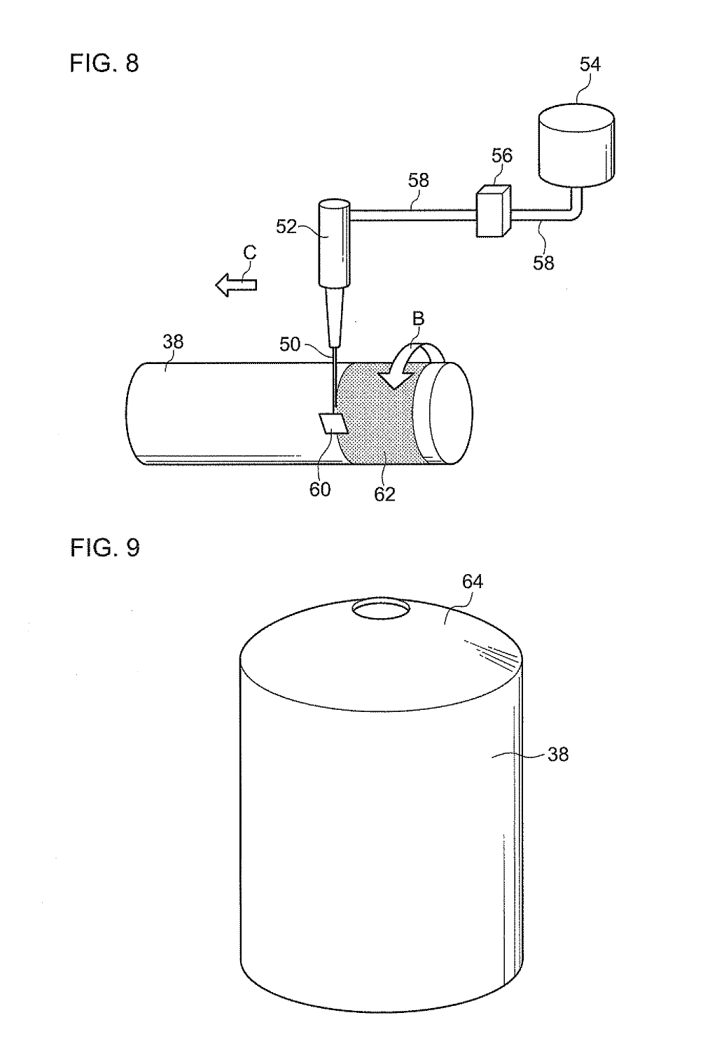

FIG. 8 is a diagram explaining the spiral coating method. In the spiral coating method, a film-forming resin solution 50 is discharged from a flow-down device 52 while the cylindrical core body 38 is rotated around its axis with its axial direction directed horizontally, such that the film-forming resin solution attaches to the surface of the cylindrical core body, as shown in FIG. 8. The film-forming resin solution 50 is supplied from a tank 54, in which the film-forming resin solution 50 is stored, to the flow-down device 52 through a supply pipe 58 due to the action of a pump 56. The film-forming resin solution 50 attached to the surface of the cylindrical core body 38 is smoothened by a spatula 60. The cylindrical core body 38 is rotated around its axis in the direction indicated by an arrow B with its axial direction directed horizontally, by the rotation device of the present exemplary embodiment.

An example of the flowing-down device 52 in the present exemplary embodiment is a mohno pump.

The flow-down device 52 and the spatula 60 are supported so as to be movable in the axial direction of the cylindrical core body 38. While the cylindrical core body 38 is rotated at a predetermined rotational velocity, and the flow-down device 52 and the spatula 60 are moved in the axial direction of the cylindrical core body 38 (the direction indicated by an arrow C), the film-forming resin solution 50 is discharged, as a result of which the film-forming resin solution 50 is spirally applied to the surface of the cylindrical core body 38. The resultant spiral streaks are removed by smoothing the applied film-forming resin solution 50 by the spatula 60, so that a seamless coating film 62 is formed. The thickness of the finished coating film is adjusted, as necessary, within a range of from 50 μm to 150 μm.

Drying Process

The method of producing an endless band-shaped body according to the present exemplary embodiment includes a drying process of drying a coating film formed on the outer circumferential surface of the rotating cylindrical core body.

Specifically, it is preferable to dry the coating film by heating while the cylindrical core body is rotated by the above-described rotation device. In regard to the heating conditions, the heating is preferably conducted for from 10 minutes to 60 minutes at a temperature of from 80° C. to 200° C. As the temperature is elevated, the heating time and the drying time can be made shorter. It is also effective to blow hot air for heating. During heating, the heating temperature may be increased stepwise or at a constant rate. The cylindrical core body may be slowly rotated at from about 5 rpm to about 60 rpm during heating, so as to prevent drooping of the coating film.

In a case in which a masking member has been provided after drying, the masking member is removed. By removing the masking member, a gap (clearance) is provided between at least a part of an end portion of the dried coating film and the cylindrical core body. An endless belt is produced with ease and efficiency by blowing gas into the gap, and extracting, from the cylindrical core body, the resin film obtained after being subjected to the heating process described below. Further, since excessively strong force is not applied when the resin film is extracted, generation of defective products is prevented.

Heating Process

The method of producing an endless band-shaped body according to the present exemplary embodiment may include a heating process of forming a resin film by solidifying the dried coating film by heating.

The heating process is necessary in a case in which a material that undergoes a hardening reaction when heated, such as a PI precursor, is used as the film-forming resin.

In the heating process, the cylindrical core body is placed and heated in a heating furnace. The heating temperature is preferably from about 250° C. to about 450° C., and more preferably from about 300° C. to about 350° C. The film of a PI precursor is heated for from 20 minutes to 60 minutes to cause an imidization reaction, thereby forming a PI resin film. At the time of the heating reaction, it is preferable that the temperature is increased stepwise or increased gradually at a constant rate, before reaching the final heating temperature.

In a case in which the film-forming resin is a PAI, removal of the solvent by heating directly results in formation of a film.

The rolls present in the rotation device do not have sufficient heat resistance for such high temperatures. Therefore, in the heating process, it is preferable that the cylindrical core body is placed in the heating furnace after being unloaded from the rotation device. Usually, the cylindrical core body is placed in the heating furnace in a state in which the axial direction of the cylindrical core body matches the gravitational direction, i.e., the cylindrical core body allowed to stand vertically is placed in the heating furnace. The heating furnace preferably has a configuration in which hot air is blown from the upper side of the vertically standing cylindrical core body, in order to prevent the generation of unevenness in the temperature inside the heating furnace as far as possible. Further, in order to prevent the hot air from being directly blown to an upper part of the cylindrical core body, a shielding member that shields the air may be provided at the upper part of the cylindrical core body. The shielding member is not particularly limited with respect to the shape thereof, as long as the shielding member is able to cover one end of the cylindrical core body.

After the heating is completed, the cylindrical core body is taken out from the heating furnace, and the film formed is extracted from the cylindrical core body, as a result of which an endless band-shaped body is obtained. Before the film is extracted from the cylindrical core body, pressurized air may be blown into a gap between an end portion of the film and the cylindrical core body that is generated by removal of the masking member, so as to cancel tight adhesion between the film and the cylindrical core body; extraction of the film from the cylindrical core body is facilitated thereby. Since defects such as wrinkles or uneven film thickness are present at an end portion of the film thus obtained, the unnecessary portion is cut off, and an endless band-shaped body is obtained. The endless band-shaped body is optionally subjected to a hole-formation process, a rib attachment process, or the like.

The endless belt obtained according to the present exemplary embodiment may be used in image forming devices, as a functional belt for electrophotographic copiers, laser printers, and the like.

### EXAMPLES

The present exemplary embodiment is described in more detail below by reference to examples. However, the examples should not be construed as limiting the present exemplary embodiment.

### Example 1

A plate of SUS 632 (precipitation hardening stainless steel) having a width of 500 mm, a length of 1149 mm, and a thickness of 0.3 mm is prepared for production of a cylindrical core body. The plate is rolled in its longitudinal direction, and the end portions thereof are bonded by TIG welding, as a result of which a cylindrical body having a width of 500 mm and an outer diameter of 366 mm is obtained. As shown in FIG. 1, protruding portions 22 each having an average height of about 30 μm are generated at the welding portion. After the entire cylindrical body is hardened by being subjected to heating treatment at 480° C. for one hour, the entire outer circumferential surface of the cylindrical body is grinded with a grindstone, and thereafter further subjected to buff polishing to an Ra of 0.05 μm, thereby providing a cylindrical core body. By the polishing treatment, the protruding portion 22 on the outer circumferential surface is removed. Since the protruding portion on the inner circumferential surface does not hinder the production of the endless band-shaped body, the protruding portion on the inner circumferential surface is left to remain. The weight of the cylindrical core body is 1370 g.

The surface of the cylindrical core body is roughened to an Ra of 0.4 μm by blast treatment using spherical alumina particles. After the roughening, the plate portion and the welding portion have the same Ra as each other.

Further, a silicon-based release agent (SEPACOAT (tradename) manufactured by Shin-Etsu Chemical Co., Ltd.) is applied to the surface of the cylindrical core body by spraying, and the cylindrical core body is subjected to baking treatment by being placed in a heating furnace of 300° C. for one hour. In this manner, a cylindrical core body 38 is prepared.

A device having a structure shown in FIGS. 3 and 4 is prepared as a rotation device. Specifically, rolls made of silicone rubber and having an outer diameter of 60 mm and a width of 30 mm are used as rolls 36 contacting the outer circumferential surface of the cylindrical core body 38. Two of the rolls are attached, with a spacing of 120 mm, to the side plate 32, and the other two rolls are attached, with a spacing of 120 mm, to a side plate 34, such that two rolls are arranged on each side of the cylindrical core body. The two rolls 36 attached to a side plate 32 are configured to receive a rotation force. The cylindrical core body 38 is placed thereon such that the cylindrical core body 38 contacts each of the rolls 36 with a contact width of 15 mm.

A roll obtained by providing a silicone rubber roll layer that has an outer diameter of 50 mm and a width of 530 mm on a surface of a round bar that is formed of SUS 304 and that has a diameter of 20 mm and a length of 600 mm is used as a support roll 40. The support roll 40 is disposed so as to contact the inner circumferential surface of the cylindrical core body 38 directly above the axis of the cylindrical core body 38. Only one end of the support roll 40 is supported by the side plate 32 in a manner that allows free rotation of the support roll 40. The rolls 36 and the support roll 40 are provided at positions such that the rolls 36 would touch the outer circumferential surface of the cylindrical core body 38 in an undeformed state. When the cylindrical core body 38 with the roll 36 and the support roll 40 mounted thereon has been installed in the rotation device, distortion of the upper part of the cylindrical core body 38 did not occur.

As counter rolls 42, the same rolls as the support roll 40 is used.

As shown in FIGS. 3 and 4, two counter rolls 42 are disposed to face the rolls 36, such that regions of the inner surface of the cylindrical core body 38 corresponding to the positions at which the rolls 36 contact the outer circumferential surface of the cylindrical core body 38 are provided with the counter rolls 42. The counter rolls 42 are supported by the side plate 32 in such a manner that only one end of each counter roll 42 is supported, and each counter roll 42 is freely rotatable and can be moved vertically for 20 mm. Installation of the cylindrical core body 38 into the rotation device is conducted as follows. The counter rolls 42 are moved upward, and then the cylindrical core body 38 is fitted. Thereafter, the counter rolls 42 are moved downward, so as to apply a force of 10N against the cylindrical core body 38 per one roll 36. When two rolls 36 attached to the side plate 32 is rotated in this state, the cylindrical core body 38 reliably rotates while maintaining a cylindrical shape.

Separately, to 100 parts of a PI precursor solution (U VARNISH (tradename) manufactured by UBE INDUSTRIES LTD. having a solids concentration 18%, and of which the solvent is N-methyl pyrrolidone), carbon black (SPECIAL BLACK 4 (tradename) manufactured by Degussa-Huls Corporation) in an amount of 27% in terms of solids weight ratio is added, and the resultant mixture is dispersed by a counter-collision disperser (GEANUSPY (trade name) manufactured by GEA-NUS PPRL), as a result of which a coating liquid having a viscosity of about 42 Pa·s at 25° C. is obtained.

Using the coating liquid, a PI precursor coating film is obtained according to the spiral coating method shown in FIG. 8.

The coating operation is performed by discharging the PI precursor solution, serving as a film-forming resin solution 50, at a rate of 60 ml per minute by using a mohno pump. During the coating operation, the cylindrical core body 38 is rotated at 20 rpm, and, the surface of the PI precursor solution supplied to the cylindrical core body 38 is then pressed with a spatula 60. The flowing-down device 52 and the spatula 60 are integrally moved in the axial direction of the cylindrical core body 38 at a velocity of 50 mm/minute, thereby spirally forming the coating film.

The spatula 60 used is a stainless plate having a thickness of 0.2 mm that has been processed to have a width 20 mm and a length of 50 mm. The coating width is from a position at a distance of 20 mm from one end of the cylindrical core body 38 to another position at a distance of 20 mm from the other end of the cylindrical core body 38.

After the coating, the cylindrical core body 38 is continued to be rotated for five minutes, as a result of which spiral streaks on the surface of the coating film disappeared. In this manner, a coating film having a thickness of about 500 μm is formed.

Thereafter, the cylindrical core body 38 rotated at 10 rpm is placed in a drying furnace of 150° C. by putting the entire rotation device in the drying furnace, and the cylindrical core body 38 is dried for 16 minutes. Then, the cylindrical core body 38 is taken off from the rotation device, and is placed with its axial direction directed vertically. A shielding member 64 is put on the upper part of the cylindrical core body 38, as shown in FIG. 9. The shielding member has a bottom face having an outer diameter of 366 mm, has a height of 80 mm, and has a ventilation port having a diameter of 50 mm at its center. The shielding member has been produced by processing a plate of SUS 304 having a thickness of 1 mm. The shielding member 64 prevents heated air inside the heating furnace from directly contacting the upper part of the cylindrical core body 38, and prevents an increase in the temperature of the upper part that would otherwise occur.

Then, the cylindrical core body 38 on which the shielding member 64 is disposed is put in a heating furnace, heated at 200° C. for 30 minutes, and then 300° C. for 30 minutes, thereby drying the residual solvent and allowing an imidization reaction of the PI precursor to occur. The inner diameters of the heating furnace are 1.8 m wide, 2.4 m high, and 1.5 m long. The heating furnace has a configuration in which the heating air is blown from the above and suctioned at the bottom.

After the cylindrical core body 38 cooled to the room temperature, pressurized air is blown into a gap between the cylindrical core body 38 and the resin film, and the resin film is extracted from the cylindrical core body 38, thereby providing an endless film. Further, unnecessary portions at both sides of the endless film are cut off, as a result of which an endless intermediate transfer belt having a width 360 mm is obtained. The thickness of the endless intermediate transfer belt is measured at a total of 50 points (10 points in the circumferential direction×5 points in the axial direction) by a dial gauge, and the average film thickness of the endless intermediate transfer belt is found to be 80 μm. Further, although positions of the belt corresponding to the welding portion of the cylindrical core body 38 are observed carefully, streaks or film thickness abnormality due to protruding portions are not found.

### Comparative Example 1

When the cylindrical core body is stretched by being wound around two rolls 12 as shown in FIG. 11, the diameter of the roll 12 is preferably 1000 times the thickness of the cylindrical core body from the viewpoint of successfully deforming the cylindrical core body.

Consequently, in order to stretch the cylindrical core body 38 used in Example 1 by winding the cylindrical core body 38 around two rolls 12 as shown in FIG. 11, the diameters of the rolls need to be at least 300 mm since the thickness of the cylindrical core body 38 used in Example 1 is 0.3 mm. However, since the cylindrical core body 38 of Example 1 has a diameter of 366 mm, it is not possible to arrange two rolls having a diameter of 300 mm.

In the case of using rolls having a diameter of 200 mm, two rolls having a diameter of 200 mm can be arranged if the distance between the centers of the rolls is set to 260 mm. However, when this arrangement is tried by forcibly deforming the cylindrical core body 38 so as to stretch the cylindrical core body 38 by winding around the two rolls 12, the cylindrical core body 38 did not return to its original shape, and thus the cylindrical core body 38 cannot be rotated.

### Example 2

The process of Example 1 is modified such that the cylindrical core body after welding is used without being subjected to the heating treatment. Specifically, polishing is performed without removing the protruding portions 22 each having an average height of about 30 μm that is present in the welding portion as shown in FIG. 1. When the polishing finished, the height of the protruding portion has decreased to about 10 μm. An endless band-shaped body is produced in the same manner as Example 1, except the above.

The average film thickness of the endless band-shaped body thus obtained is 80 μm. When positions corresponding to the welding portion of the cylindrical core body are observed, streaks are found, and the film thicknesses of the streak portions are found to vary between 75 μm and 85 μm. When this endless band-shaped body is used as an intermediate transfer belt, the streaks cause corresponding density unevenness stripes in the resultant images. However, this endless band-shape body is nevertheless usable as a paper transport belt.

### Example 3

A plate of SUS 301 (austenite-based stainless steel) having a width of 1 m, a length of 2920 mm, and a thickness of 1.2 mm is prepared for production of a cylindrical core body. The plate is rolled in its longitudinal direction, and the end portions thereof are bonded by TIG welding, as a result of which a cylindrical body having a width of 1 m and an outer diameter of 930 mm is obtained. As shown in FIG. 1, protruding portions 22 each having an average height of about 50 μm are generated at the welding portion. The entire cylindrical body is heated subjected to solution heat treatment by being heated at 1050° C. for one hour. Thereafter, the entire outer circumferential surface of the cylindrical body is grinded with a grindstone, and then further subjected to buff polishing to an Ra of 0.05 μm, thereby providing a cylindrical core body. As a result, the protruding portion 22 on the outer circumferential surface is removed. Since the protruding portion on the inner circumferential surface does not hinder the production of the endless band-shaped body, the protruding portion on the inner circumferential surface is left to remain. The weight of the core body is 27.9 kg. When the cylindrical core body is supported by two rolls as shown in FIG. 2, the cylindrical core body deforms such that the top of the cylindrical core body is about 40 mm lower than that of the cylindrical shape.

Next, the surface of cylindrical core body is roughened to an Ra of 0.4 μm by blast treatment using spherical alumina particles. After the roughening, the plate portion and the welding portion have the same Ra as each other.

Further, a silicon-based release agent (SEPACOAT (tradename) manufactured by Shin-Etsu Chemical Co., Ltd.) is applied to the surface of the cylindrical core body by spraying, and the cylindrical core body is subjected to baking treatment by being placed in a heating furnace of 300° C. for an hour.

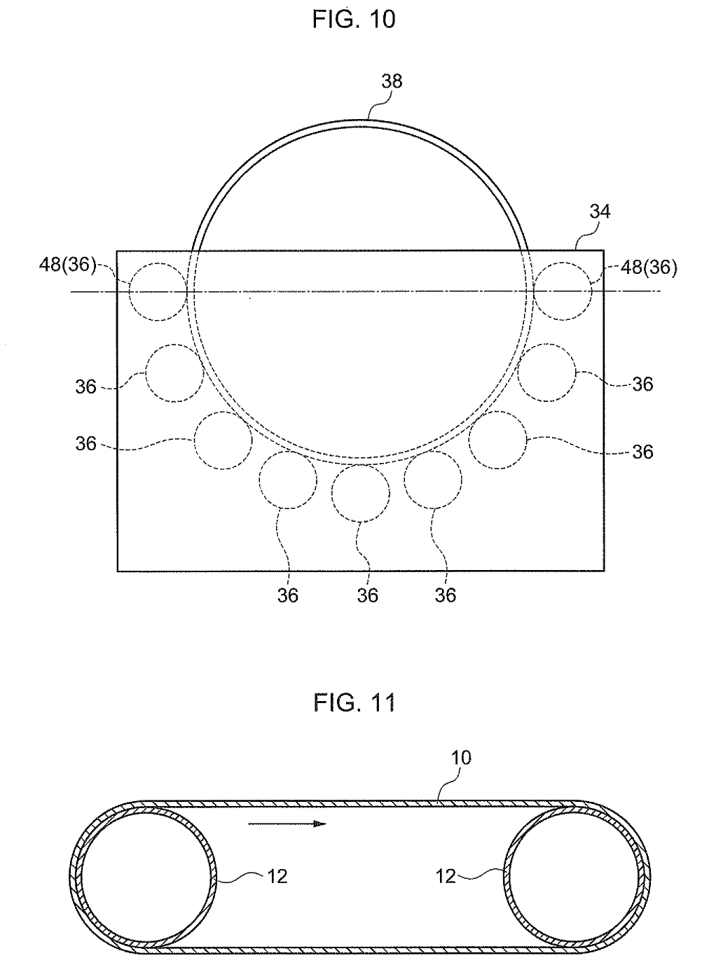

In the Example 3, a device having a structure shown in FIG. 10 is used as a rotation device. Specifically, rolls made of silicone rubber and having an outer diameter of 60 mm and a width of 30 mm are used as rolls 36. When L is set to L=930, at least nine rolls 36 are necessary per side according to the equation, N=L/100. Thus, as shown in FIG. 10, nine rolls 36 are attached to each of a side plate 32 and a side plate 34. The positions of the rolls 36 arranged are such that the rolls 36 are arranged at the same distance from the axis of the cylindrical core body and at constant intervals. Further, rolls 36 (pinching rolls 48) are disposed at positions such that the pinching rolls 48 would respectively touch the positions at which a horizontal imaginary line passing through the axis of the cylindrical core body 38 in an undeformed state intersects with the outer circumference of the cylindrical core body in an undeformed state. Further, a rotational force is applied to all of the rotatable members.

The cylindrical core body is mounted on the rotation device, and is rotated. The cylindrical core body is smoothly rotated over a range of from 5 rpm and 50 rpm without undergoing deformation or uneven rotation.

The cylindrical core body is rotated, the same PI precursor solution as that used in Example 1 is applied in the same manner, and an endless band-shaped body is prepared through the same processes as in Example 1 except the above. The endless band-shaped body obtained has a film thickness of 80 μm. Although positions of the belt corresponding to the welding portion of the cylindrical core body is observed carefully, the streaks or film thickness abnormality due to protruding portion are not found.

### Comparative Example 2

When one end of the cylindrical core body used in Example 3 is pressed into an elliptical shape of which the minor axis has a length of 600 mm, the deformation becomes permanent since the cylindrical core body used in Example 3 is thick, and a cylindrical shape cannot be recovered. Thus, it is impossible to stretch the cylindrical core body by winding the cylindrical core body around two rolls 12 as shown in FIG. 11.

### Comparative Example 3

A plate of SUS 632 (the same material as that used in Example 1) having a width of 500 mm, a length 2920 mm, and a thickness of 0.3 mm is prepared for production of a cylindrical core body. The plate is rolled in its longitudinal direction, and the end portions thereof are bonded by TIG welding, as a result of which a cylindrical body having a width of 500 mm and an outer diameter of 930 mm is obtained. As shown in FIG. 1, protruding portions 22 each having an average height of about 30 μm are generated at the welding portion. After the entire cylindrical body is hardened by being subjected to heating treatment at 480° C. for one hour, the entire outer circumferential surface of the cylindrical body is grinded with a grindstone, and thereafter further subjected to buff polishing to an Ra of 0.05 μm, thereby providing a cylindrical core body. As a result, the protruding portion 22 on the outer circumferential surface is removed. The protruding portion on the rear surface is removed by polishing in a similar manner, thereby providing a smooth surface.

The cylindrical core body is stretched by being wound around two rolls 12 as shown in FIG. 11. Since this cylindrical core body has a large outer diameter, it is possible to arrange two rolls 12 having a diameter of 300 mm with a distance between the centers of the rolls of 989 mm, unlike Example 1. Two steel rolls which have a diameter of 300 mm and a length of 600 mm, and of which the surfaces have been subjected to hard chrome plating are arranged to stretch the cylindrical core body. When the cylindrical core body is rotated at a rotation velocity of 50 rpm, the cylindrical core body is gradually shifted in one axial direction by each rotation, and adjustment of the rolls is hardly effective for avoiding this phenomenon. Therefore, when a coating method involving a very large number of revolutions of the cylindrical core body as in the case of the spiral coating method, the cylindrical core body inevitably shifts to one side, and the rotation cannot be continued. This phenomenon is thought to be caused by a slight difference between the circumferential lengths of both ends of the cylindrical core body, and complete prevention of this phenomenon is thought to be impossible in view of practically achievable processing accuracy.

What is claimed is:

1. A method of producing an endless band-shaped body, comprising:
an application process of forming a coating film by applying a film-forming resin solution to an outer circumferential surface of a cylindrical core body that is being rotated around an axis of the cylindrical core body by a rotation device in a state in which the axis of the cylindrical core body is horizontally directed, the cylindrical core body undergoing deformation into an oval cylindrical shape due to its own weight when left unsupported in a state in which the axis of the cylindrical core body is directed horizontally; and
a drying process of drying the coating film formed on the outer circumferential surface of the rotating cylindrical core body,
the rotation device including at least one first roll and at least one second roll,
the at least one first roll being disposed at at least one position such that the at least one first roll would touch a first end region of the outer circumferential surface of the cylindrical core body in an undeformed state, the first end region being located at one end in the axial direction of the cylindrical core body,
the at least one second roll being disposed at at least one position such that the at least one second roll would touch a second end region of the outer circumferential surface of the cylindrical core body in an undeformed state, the second end region being located at the other end in the axial direction of the cylindrical core body, and
the cylindrical core body being supported by the first and second rolls.

2. The method of producing an endless band-shaped body according to claim 1, wherein the rotation device further includes a support roll that contacts a region of an inner circumferential surface of the cylindrical core body, and the region is located at an upper side, in terms of a vertical direction, of an axial position of the cylindrical core body.

3. The method of producing an endless band-shaped body according to claim 2, wherein no roll is disposed at a position on the outer circumferential surface of the cylindrical core body that is opposite to the support roll.

4. The method of producing an endless band-shaped body according to claim 1, wherein the at least one first or second roll includes a pair of pinching rolls that are disposed such that the pinching rolls would respectively touch positions at which a horizontal imaginary line passing through the axis of the cylindrical core body in the undeformed state intersects with an outer circumference of the cylindrical core body in the undeformed state when the cylindrical core body is viewed in the axial direction.

5. The method of producing an endless band-shaped body according to claim 4, wherein at least one of the at least one first or second roll is disposed at a lower side, in terms of a vertical direction, of the axis of the cylindrical core body in an undeformed state.

6. The method of producing an endless band-shaped body according to claim 1, wherein the cylindrical core body is obtained by:
rolling a quadrilateral metallic plate;
bonding both ends of the rolled quadrilateral metallic plate by welding, thereby forming a cylindrical body;
subjecting the cylindrical body to heat treatment; and
thereafter polishing an outer circumferential surface of the cylindrical body.

7. The method of producing an endless band-shaped body according to claim 1, wherein at least one of the at least one first or second roll is disposed opposite to a corresponding counter roll that contacts an inner circumferential surface of the cylindrical core body.

8. The method of producing an endless band-shaped body according to claim 1, wherein at least one of the at least one first or second roll is disposed at a lower side, in terms of a vertical direction, of the axis of the cylindrical core body in an undeformed state.

9. The method of producing an endless band-shaped body according to claim 1, wherein the rotation device satisfies the following inequalities:
L/100≦N₁≦L/50
L/100≦N₂≦L/50
wherein, in the inequalities, L represents a diameter of the cylindrical circular body in an undeformed state, N₁ represents a total number of the at least one first roll, and N₂ represents a total number of the at least one second roll.

10. The method of producing an endless band-shaped body according to claim 1, wherein a total number of the at least one first roll is 4 or greater, and a total number of the at least one second roll is 4 or greater.

11. The method of producing an endless band-shaped body according to claim 1, wherein a total number of the at least one first roll is 18 or greater, and a total number of the at least one second roll is 18 or greater.

12. The method of producing an endless band-shaped body according to claim 1, wherein the at least one first or second roll includes a roll T that extends beyond an axial end of the cylindrical core body in the axial direction of the cylindrical core body, and the roll T has, in a region not contacting the cylindrical core body, a portion at which a diameter of the roll T is larger than a diameter of roll T in a region contacting the cylindrical core body.

13. The method of producing an endless band-shaped body according to claim 1, wherein the rotation device further comprises a regulation member that contacts an axial end surface of the cylindrical core body and that regulates movement of the cylindrical core body in the axial direction of the cylindrical core body.

14. The method of producing an endless band-shaped body according to claim 1, wherein the outer circumferential surface of the cylindrical core body has an arithmetic average roughness Ra of from about 0.2 μm to about 2 μm.

15. The method of producing an endless band-shaped body according to claim 1, wherein the film-forming resin solution comprises a polyimide resin or a polyamideimide resin.

16. The method of producing an endless band-shaped body according to claim 1, wherein no roll contacts a central region of the outer circumferential surface of the cylindrical core body and the central region extends over a region at a distance of S×20/140 to S×120/140 from one axial end of the cylindrical core body in the axial direction, where S represents a length of the cylindrical core body in the axial direction.

17. The method of producing an endless band-shaped body according to claim 1, wherein no roll contacts a central region of the outer circumferential surface of the cylindrical core body and the central region extends over a region at a distance of about S×5/110 to about S×105/110 from one axial end of the cylindrical core body in the axial direction, where S represents a length of the cylindrical core body in the axial direction.
